(19) United States
(12) Patent Application Publication
(10) Pub. No.: US 2020/0320435 A1
(43) Pub. Date: Oct. 8, 2020

(54) MULTI-LEVEL INTROSPECTION FRAMEWORK FOR EXPLAINABLE REINFORCEMENT LEARNING AGENTS

(71) Applicant: SRI International, Menlo Park, CA (US)

(72) Inventors: Pedro Daniel Barbosa Sequeira, Palo Alto, CA (US); Melinda T. Gervasio, Mountain View, CA (US); Chih-hung Yeh, Alameda, CA (US)

(21) Appl. No.: 16/842,265

(22) Filed: Apr. 7, 2020

Related U.S. Application Data
(60) Provisional application No. 62/830,683, filed on Apr. 8, 2019.

(51) Int. Cl. G06N 20/00; G06N 5/04

(52) U.S. Cl. CPC G06N 20/00; G06N 5/04

(57) ABSTRACT

Techniques are disclosed for applying a multi-level introspection framework to interaction data characterizing a history of interaction of a reinforcement learning agent with an environment. The framework may apply statistical analysis and machine learning methods to interaction data collected during the RL agent's interaction with the environment. The framework may include a first (“environment”) level that analyzes characteristics of one or more tasks to be solved by the RL agent to generate elements, a second (“interaction”) level that analyzes actions of the RL agent when interacting with the environment to generate elements, and a third (“meta-analysis”) level that generates elements by analyzing combinations of elements generated by the first level and elements generated by the second level.

This application claims the benefit of U.S. Provisional Application No. 62/830,683, entitled “Interestingness Elements for Explainable Reinforcement Learning,” and filed on Apr. 8, 2019. The entire contents of Application No. 62/830,683 is incorporated herein by reference.

### TECHNICAL FIELD

This disclosure generally relates to machine learning systems.

### BACKGROUND

An autonomous system is a robot, machine, or software agent that performs behaviors or tasks with a high degree of autonomy. An autonomous system is typically capable of operating for an extended period of time with limited or no human intervention. A typical autonomous system is capable of gathering information about its environment and acting in the environment without human assistance. Further, an autonomous system uses such information collected from the environment to make independent decisions to carry out objectives.

Some autonomous systems may implement a machine learning system, such as a reinforcement learning agent that learns policies, e.g., mappings from states to actions to perform a specified task. Machine learning systems may require a large amount of training data to build an accurate model. However, once trained, machine learning systems may be able to perform a wide variety of tasks previously thought to be capable only by a human being. For example, autonomous systems that implement machine learning systems may be well suited to tasks in fields such as spaceflight, household maintenance, wastewater treatment, delivering goods and services, military applications, cyber security, network management, artificial intelligence assistants, and augmented reality or virtual reality applications.

### SUMMARY

In general, the disclosure describes introspective analysis techniques to facilitate explainable reinforcement learning (RL) agents. For example, an explanation system may examine, using a multi-level introspection framework, a history of interaction of an RL agent with an environment to generate result data having elements denoting one or more characteristics of the RL agent interactions. The multi-level introspection framework described herein selects for elements having characteristics that tend to denote meaningful situations, i.e., potentially “interesting” characteristics of the interaction that tend to best explain the RL agent's behavior, including its capabilities and limitations in a task of interest, to a user or analysis system.

The multi-level introspection framework applies statistical analysis and machine learning methods to interaction data collected during the RL agent's interaction with the environment. The multi-level introspection framework may include a first (“environment”) level that analyzes characteristics of one or more tasks to be solved by the RL agent to generate elements, a second (“interaction”) level that analyzes actions of the RL agent when interacting with the environment to generate elements, and a third (“meta-analysis”) level that generates elements by analyzing combinations of elements generated by the first level and elements generated by the second level.

The techniques of this disclosure may have one or more technical advantages that realize at least one practical application. For example, an explanatory system using the multi-level introspection framework may be domain-independent in that the interaction data collected and analyzed is agnostic to the environment, e.g., specific learning scenario and problems to solve. Unlike other approaches, the techniques may avoid an operator having to make manual adjustments to extract meaningful information for a particular domain. As another example, the multi-level introspection framework may be algorithm-independent in that it can be used in conjunction with standard reinforcement learning tabular methods without having to modify the learning mechanism of the reinforcement learning agent. As another example, the multi-level introspection framework may avoid having to make assumptions with regards to optimality of the observed behavior—it captures important aspects specific to a given history of interaction independently of whether the agent was exploring the environment or exploiting its knowledge after learning. Unlike other approaches for explainable RL, the framework can also be used to analyze behavior exhibited by a human agent so long as the data on which the framework relies was collected during the interaction with the environment. As a still further example, the multi-level introspection framework may be flexibly applied with different modes at different RL stages. For instance, while most explainable RL approaches focus on one particular explanation form performed after the RL agent has completed learning, the framework described herein may be suitable to be used for different modes and at different times, such as: during learning by tracking the agent's learning progress and acquired preferences; after learning by summarizing the most relevant aspects of the interaction; passively, where a user can query the agent regarding its current goals and to justify its behavior at any given situation; and proactively, where the RL agent requests input from the user in situations where its decision-making is more uncertain or unpredictable.

In one example, this disclosure describes a computing system comprising: a computation engine comprising processing circuitry, wherein the computation engine is configured to obtain interaction data generated by a reinforcement learning agent, the interaction data characterizing one or more tasks in an environment and characterizing one or more interactions of the reinforcement learning agent with the environment, the one or more interactions performed according to trained policies for the reinforcement learning agent, wherein the computation engine is configured to process the interaction data to apply a first analysis function to the one or more tasks to generate first elements, wherein the computation engine is configured to process the interaction data to apply a second analysis function to the one or more interactions to generate second elements, the first analysis function different than the second analysis function, wherein the computation engine is configured to process at least one of the first elements and the second elements to generate third elements denoting one or more characteristics of the one or more interactions, and wherein the computation engine is configured to output an indication of the third elements to a user to provide an explanation of the one or more interactions of the reinforcement learning agent with the environment.

In another example, this disclosure describes a method of explainable reinforcement learning, the method comprising: obtaining, by a computing system, interaction data generated by a reinforcement learning agent, the interaction data characterizing one or more tasks in an environment and characterizing one or more interactions of the reinforcement learning agent with the environment, the one or more interactions performed according to trained policies for the reinforcement learning agent; processing, by the computing system, the interaction data to apply a first analysis function to the one or more tasks to generate first elements; processing, by the computing system, the interaction data to apply a second analysis function to the one or more interactions to generate second elements, the first analysis different than the second analysis; processing, by the computing system, at least one of the first elements and the second elements to generate third elements denoting one or more characteristics of the one or more interactions; and outputting, by the computing system, an indication of the third elements to a user to provide an explanation of the one or more interactions of the reinforcement learning agent.

In another example, this disclosure describes a non-transitory computer-readable medium comprising instructions for causing one or more programmable processors to: obtain interaction data generated by a reinforcement learning agent, the interaction data characterizing one or more tasks in an environment and characterizing one or more interactions of the reinforcement learning agent with the environment, the one or more interactions performed according to trained policies for the reinforcement learning agent; process the interaction data to apply a first analysis function to the one or more tasks to generate first elements; process the interaction data to apply a second analysis function to the one or more interactions to generate second elements, the first analysis different than the second analysis; process at least one of the first elements and the second elements to generate third elements denoting one or more characteristics of the one or more interactions; and output an indication of the third elements to a user to provide an explanation of the one or more interactions of the reinforcement learning agent.

The details of one or more examples of the techniques of this disclosure are set forth in the accompanying drawings and the description below. Other features, objects, and advantages of the techniques will be apparent from the description and drawings, and from the claims.

### BRIEF DESCRIPTION OF DRAWINGS

FIG. 1 is a block diagram illustrating an example system for facilitating eXplainable Reinforcement Learning (XRL) with an explanation system for a reinforcement learning (RL) agent, in accordance with techniques of this disclosure.

FIG. 2 is a block diagram illustrating an example computing system configured to execute systems of FIG. 1 in accordance with the techniques of the disclosure.

FIG. 3 is a block diagram illustrating an example of multi-level introspection framework of FIG. 1 in further detail, in accordance with the techniques of the disclosure.

FIG. 4 is a flowchart illustrating an example mode of operation for a computing system that implements an introspection framework to facilitate XRL, in accordance with one or more techniques of this disclosure.

Like reference characters refer to like elements throughout the figures and description.

### DETAILED DESCRIPTION

Reinforcement learning (RL) is a popular computational approach for autonomous agents facing a sequential decision problem in dynamic and often uncertain environments. The goal of any RL algorithm is to learn a policy, i.e., a mapping from states to actions, given trial-and-error interactions between the agent and an environment. Typical approaches to RL focus on memoryless (reactive) agents that select their actions based solely on their current observation. This means that by the end of learning, an RL agent can select the most appropriate action in each situation—the learned policy ensures that doing so will maximize the reward received by the agent during its lifespan, thereby performing according to the underlying task assigned by its designer.

RL agents do not need to plan or reason about their future to select actions, which makes it hard to explain their behavior—all an RL agent has knowledge of is to perform a particular action given a state, in the case of deterministic policies, or select an action according to a probability distribution, in the case of stochastic policies. The reason or explanation behind decision-making is lost during the learning process as the policy converges to an optimal action-selection mechanism. At most, agents know that choosing one action is preferable over others, or that some actions are associated with a higher value—but not why that is so or how the action became preferable. Reinforcement learning further complicates explainability by enabling an RL agent to learn from delayed rewards—the reward received after executing some action is propagated back to the states and actions that led to that situation, meaning that important actions may be associated with any (positive) reward.

Ultimately, RL agents lack the ability to know why some actions are preferable over others, to identify the goals that they are currently pursuing, to recognize what elements are more desirable, to identify situations that are “hard to learn”, or even to summarize the strategy learned to solve the task. This lack of self-explainability can be detrimental to establishing trust with human collaborators who may need to delegate critical tasks to agents.

Conventional approaches at fostering eXplainable Reinforcement Learning (XRL) involve language templates to translate elements of the problem into human-understandable explanations. Other approaches focus on abstracting state representations of the task and creating graph structures denoting the agent's behavior. Other approaches attempt to identify key moments of an RL agent's interaction to summarize its behavior. Such conventional approaches typically require a great deal of manual adjustments for specific knowledge domains or environment domains. Moreover, while conventional approaches can summarize the agent's behavior, such approaches do not perform an analysis of the reasons of behavior and thus cannot provide insights about the agent's decision-making. In addition, conventional approaches lack the capability of automatically detecting situations requiring external human intervention. Finally, conventional XRL systems operate only after learning has completed, which makes it difficult to recover key aspects of the agent's interaction with the environment.

Described herein is a system that applies a multi-level introspection framework to generate elements that characterize interactions of the RL agent with an environment and that may enable human operators or designers to correctly understand an RL agent's aptitude in a specific task, i.e., both its capabilities and limitations, whether innate or learned. The multi-level introspection framework relies on generic data that is already collected by standard RL algorithms and on a factored-state structure, which may enable domain independence and avoidance of manual adjustments. The framework may further provide analysis of reasons for an RL agent's behavior to provide insights about the agent's decision-making. The framework may also enable automatic detection of situations requiring human intervention and output a request for such intervention, e.g., in the form of a decision. The framework described herein may be suitable to be used for different modes and at different times. With added trust in an RL agent facilitated by explainability provided by techniques described herein, the user may delegate tasks more appropriately as well as identify situations where the RL agent's perceptual, actuating, or control mechanisms may need to be adjusted prior to deployment.

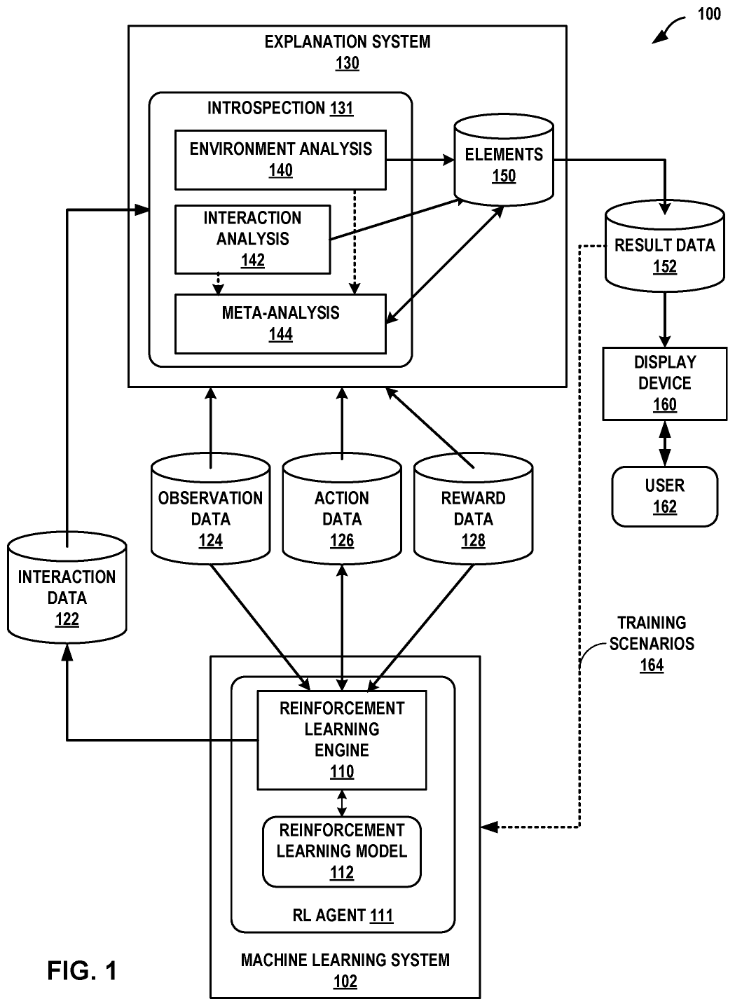

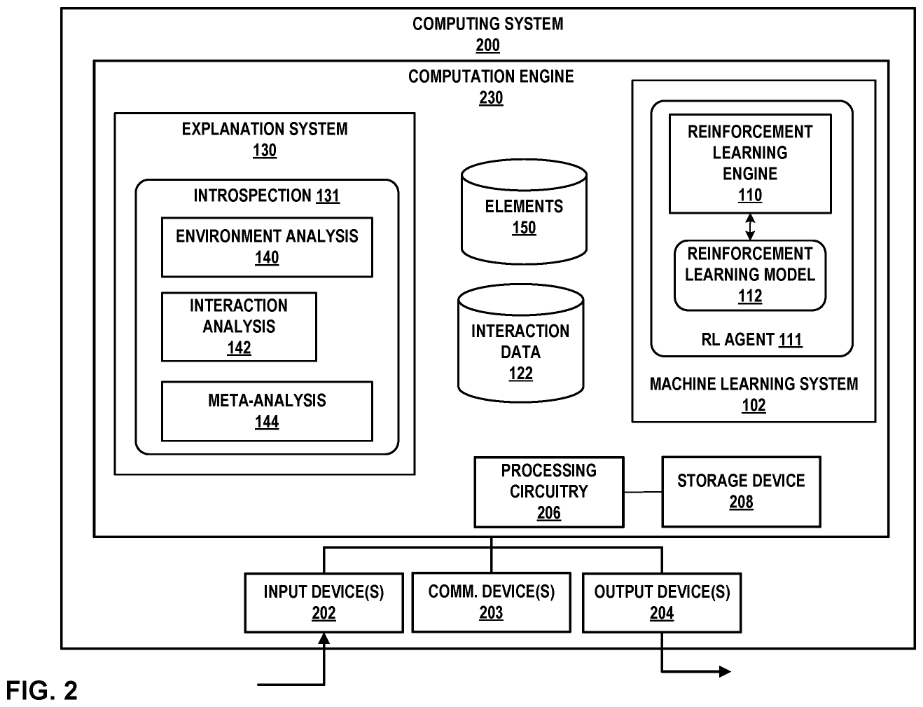

FIG. 1 is a block diagram illustrating an example system 100 for facilitating eXplainable Reinforcement Learning (XRL) with an explanation system 130 for a reinforcement learning (RL) agent 111, in accordance with techniques of this disclosure. Machine learning system 102 executes a reinforcement learning engine 110 executes at least one reinforcement learning algorithm to train reinforcement learning model 112 for operation in an environment. Machine learning system 102 represents one or more computing devices to perform operations described herein to process reward data 128, as well as observations from actions 122 taken by RL agent 111 within an environment, to train reinforcement learning model 112. For example, machine learning system 102 may include processing circuitry and memory as described in further detail with respect to FIG. 2. In general, an environment represents a task or simulation to be solved by RL agent 111. An environment may include, for example, a digital assistant task, a software-controlled network, operations for an autonomous vehicle, a robotic device or a factory with many such robotic devices, a medical therapy, or a home automation environment. Accordingly, RL agent 111 may be included within a digital conversational assistant, a network controller, an autonomous vehicle, an industrial control system, a home automation system, or a medical device such an automated pump or defibrillator, among other examples.

An RL agent can be modeled using the partially observable Markov decision process (POMDP) framework, denoted as a tuple M=(S, A, Z, P, O, R, γ). At each time step t=0, 1, 2, . . . , the environment is in some state Sₜ=s∈S. RL agent 111 selects some action Aₜ=a∈A and the environment transitions to state Sₜ₊₁=s′∈S with probability P(s′|s, a). The RL agent 111 receives a reward R(s, a)=r∈R and makes an observation Zₜ₊₁=z∈Z with probability O(z|s′, a), and the process repeats. In the context of FIG. 1, observation data 124 stores observations Z, action data 126 stores actions A, and reward data 128 stores rewards R.

RL agent 111 may obtain observation data 124 via one or sensors such as cameras, feedback devices, proximity sensors, infrared sensors, accelerometers, temperature sensors, and so forth (not shown) operating in the environment to observe the environment. RL agent 111 may or may not be located within the environment. The environment may or may not include a physical space but is generalizable as a task to be solved, and RL agent 111 may be considered “within” the environment when it is operating to solve the task in learning mode or other mode.

In some situations, the RL agent 111 may have limited sensing capabilities or receive only partial observation data, i.e., the environment may be partially-observable. Notwithstanding, as in typical RL scenarios, the observation data 124 is presumed sufficient for RL agent 111 to solve the intended task, in which case Z is treated as if it were S (that is, the observations are treated as if they are equal to the underlying true states), and O is discarded. A simplified model is thus obtained, represented as a tuple M=(S, A, P, R, γ), and referred to as a Markov decision process (MDP).

The goal of RL agent 111 can be formalized as that of gathering as much reward as possible throughout its lifespan discounted by γ. This corresponds to maximizing the value ν=E[Σₜγ^{t}r]. This is referred to as the value function or V function, V(s), which depends on the policy by which the RL agent 111 selects actions to perform. To that end, RL agent 111 must learn a policy, denoted by π: Z→A, that maps each observation z∈Z directly to an action π(z)∈A. (Z=S is used to denote the set of all possible observations and symbol z is used to refer to singular observations.) In the case of MDPs, this corresponds to learning a policy π*: S→A, referred to as the optimal policy maximizing the value ν. For value-based RL methods, a function Q*: S×A→R associated with π* verifies the recursive relation

$${Q}^{*} ( s , a ) = r + γ P ( {s}^{′} \vert s , a ) {Q}^{*} b ∈ A ( {s}^{′} , b ) .$$

Q*(s, a) represents the value of executing action a in state s and henceforth following the optimal policy. The Q function may be referred to as the state-action pair value function. V*(s) is the maximum expected total reward when starting from state s and is the maximum of Q*(s, a) over all possible actions. Standard RL algorithms like Q-learning assume that the RL agent has no knowledge of either P or R. Hence, RL agent 111 may start by exploring the environment—by selecting actions in some exploratory manner—such as by collecting samples in the form (s, a, r, s′) which are then used to successively approximate Q* using the above recursion. After exploring, RL agent 111 can exploit its knowledge and select the actions that maximize (its estimate of) Q*.

By explorations with action selection, RL agent 111 interacts with its environment to make observations, take actions, and transition to different environment states. In accordance with techniques described in this disclosure, RL agent 111 generates or collects interaction data 122. Interaction data 122 may include:

n(z): the number of times RL agent 111 observed z; n(z, a): the number of times RL agent 111 executed action a after observing z (an observation-action pair); and n(z, a, z′): the number of times RL agent 111 observed z′ after executing action a when observing z;

\hat{P}(z, a, z′): the estimate by RL agent 111 of the probability of observing z′ when executing action a after observing z. This may be referred to as a transition probability function. This can be modeled from the interactions according to \hat{P}(z′|z, a)=n(z, a, z′)/n(z, a);

\hat{R}(z, a): the estimate by RL agent 111 of the reward received for performing an action a after observing z. RL agent 111 can estimate \hat{R} by maintaining a running average of the rewards received;

Q(z, a): the estimate by RL agent 111 of the Q function, corresponding to the expected value of executing a having observed z and henceforth following the current policy. This can be estimated using any value-based RL algorithm;

[symbol] (z, a) is the expected prediction (Bellman) error associated with Q(z, a). For a transition (z, a, r, z′), the prediction error corresponds to

$$Δ Q ( z , a ) = r + γ Q ( {z}^{′} , b ) - Q ( z , a ) .$$

As such, the agent can maintain a running average of the prediction errors after each visit to (z, a);

V(z): the agent's estimate of the V function that indicates the value of observing z and henceforth following the current policy. This corresponds to

$$V ( z ) = Q ( z , a ) .$$

RL agent 111 generates some of the interaction data 122 using value-based RL methods, e.g., the Q function. RL agent 111 generates some of the interaction data 122 using model-based algorithms, such as \hat{P} and \hat{R}. In accordance with techniques described herein, RL agent 111 generates other interaction data 122 during interactions with the environment by updating counters and computing averages. In some examples, interaction data 122 includes at least some of each of observation data 124, action data 126, and reward data 128.

In addition, as is the case with many RL scenarios, at each time-step t, RL agent 111 may observe its environment through a finite set of features Zₜⁱ=zⁱ, i=1, . . . N, each taking values in some feature space Zⁱ. The observation-space thus corresponds to the cartesian product Z=Z₁× . . . ×Z_{N}. When this is the case, the structure exhibited by such factored MDPs can also be exploited to derive interesting aspects related to specific observation elements.

Explanation system 130 uses interaction data 122, such as that described above, to perform several introspection analyses using a multi-level introspection framework 131. Explanation system 130 represents a computing system including one or more computing devices to execute multi-level introspection framework 131 to generate and store elements 150. Explanation system 130 and machine learning system 102 may execute on a common computing system or different computing systems. Introspection framework 131 includes environment analysis level 140, interaction analysis level 142, and meta-analysis level 144. Each of these levels 140, 142, 144 includes one or different functions for analyzing introspection data 122 in accordance with a category of data analyzed by the level. The environment analysis level 140 analyzes characteristics of one or more tasks to be solved by the RL agent 111 (the MDP components) to generate elements 150, the interaction analysis level 142 analyzes behavior of the RL agent 111 when interacting with the environment (based on the learned value functions) to generate elements 150, and meta-analysis level 144 generates elements 150 by analyzing combinations of elements 150 generated by the environment analysis level 140 level and elements 150 generated by the interaction analysis level 142. Elements 150 represent data that highlights information that helps explain the behavior of RL agent 111.

In general, environment analysis level 140 analyzes characteristics of the task to be solved by RL agent 111. Environment analysis level 140 may detect certain and uncertain transitions that inform about how the agent can predict the consequences of its actions. Environment analysis level 140 may identify “abnormal” situations regarding the reward received by RL agent 111 during its interaction with the environment (very high/low rewards). Environment analysis level 140 may store representations of the results of its analyses as elements in elements 150. Elements 150 represent data stored in data structures and that characterize analysis results for multi-level introspection framework 131. Examples of elements 150 are described elsewhere in this disclosure.

In general, interaction analysis level 142 analyzes the environment's dynamics and extracts important aspects of the behavior of RL agent 111 during interaction with the environment. Interaction analysis level 142 may determine an amount of the state space explored and an evenness of the distribution of visits to states of the environment. Interaction analysis level 142 may also extract relevant aspects of perceptions of RL agent 111, e.g., by identifying both frequent and rare observations, and patterns in the perceptions by using frequent pattern-mining techniques. Interaction analysis level 142 may also calculate how certain or uncertain each observation is with regards to action execution. Interaction analysis level 142 may also determine how well RL agent 111 can predict the consequences and future value of its actions in most situations encountered by RL agent 111. Environment analysis level 140 may store representations of the results of its analyses as elements in elements 150.

In general, meta-analysis level 144 performs a meta-analysis by combining information gathered at environment analysis level 140 and interaction analysis level 142. For example, meta-analysis level 144 may identify local maxima and minima states, the local maxima states denoting sub-goals or acquired preferences for RL agent 111, and the local minima states denotes highly undesirable situations that the RL agent sought to avoid. Based on this information, introspection framework 131 may generate a graph representing likely transitions from any given situation (e.g., state) to a sub-goal (e.g., a local maxima). In turn, this allows the identification of situations where RL agent 111 can predict its near future (as well as how to achieve it) and situations in which the future of RL agent 111 is uncertain. Meta-analysis level 144 may automatically determine contradictory situations in which RL agent 111 behaved in unexpected or surprising ways. Finally, meta-analysis level 144 may also perform a differential analysis between two behaviors of two different instances of RL agent 111, which allows tracking the development of learning by RL agent 111 or comparing the behavior of a novice RL agent 111 against that of an expert RL agent 111 in the task. Different instances of RL agent 111 may represent different “runs” through an environment resulting in different RL models 112 for the different instances. Environment analysis level 140 may store representations of the results of its analyses as elements in elements 150.

Multi-level introspection framework 131 generates elements 150. Explanation system 130 may select certain elements from elements 150 that help to explain the behavior of RL agent 111. Explanation system 130 may output indications of selected elements 150 as result data 152. Explanation system 130 may output result data 152 for display to a display device 160 used by user 162. User 162 may be an operator of a system that includes RL agent 111, an RL agent 111 trainer, or other user. In some examples, explanation system 130 may derive explanations about the learned strategy of RL agent 111 by visualizing relevant sequences to learned goals given any situation, as represented in selected elements 150, and output this as result data 152. In some examples, explanation system 130 provide contrastive explanations by outputting justifications, as represented in selected elements 150, for why learned decisions are preferable compared to alternative actions. In some examples, explanation system 130 may be used in a proactive manner by the RL agent 111 to identify circumstances in which advice from user 162 might be needed. In such examples, explanation system 130 may derive a request for advice and output this request to user 162. The request may represent a user interface element for display at display device 160, a message, an audio request, or other request. The request may include optional actions for decision. User 162 may provide an appropriate response to explanation system 130 or directly to RL agent 111. RL agent 111 may responsively perform an action indicated by the response. Machine learning system 102 may also process the decision to modify the trained policies of reinforcement learning model 112 for RL agent 111 to perform the action indicated by the response for similar situations in the future. In some examples, explanation system 130 may identify situations in which more training is required to learn the intended task. or in which the user's input is needed to identify the correct response by RL agent 111. Examples of requests for user input in response to such identified situations are described herein, e.g., explanation system 130 may prompt a user for the most appropriate actions for states corresponding to the identified situations. In some cases, explanation system 130 may use these identified situations to generate one or more training scenarios 164 from elements 150 to assist RL agent 111. For instance, where elements 150 indicate states for which the action to be performed is uncertain, explanation system 130 may generate training scenarios 164 for such states. Machine learning system 102 may process training scenarios 164 generated from elements 150 to train reinforcement learning model 112. Training scenarios 164 may be in the form <s, a, s′, r>, including an initial state s of the environment, an action a to be performed by RL agent 111, a resulting state s′ of the environment, and a resulting reward r for RL agent 111.

As described herein, explanatory system 130 using the multi-level introspection framework 130 may therefore be domain-independent in that the interaction data 122 collected and analyzed is agnostic to the specific learning scenario, e.g., environment and problems to solve. Unlike other approaches, the techniques applied by system 100 may avoid user 162 or other operator having to make manual adjustments to extract meaningful information for a particular domain. The multi-level introspection framework 131 may be algorithm-independent in that it can be used in conjunction with standard reinforcement learning tabular methods without having to modify the learning mechanism of RL agent 111. In some examples, multi-level introspection framework 131 may be used in conjunction with non-tabular RL methods, such as Deep RL variants including DQN, among others. The multi-level introspection framework 131 may avoid having to make assumptions with regards to optimality of the observed behavior—it captures important aspects specific to a given history of interaction independently of whether RL agent 111 was exploring the environment or exploiting its knowledge after learning to realize RL model 112. Unlike other approaches for explainable RL, introspection framework 131 can also be used to analyze behavior exhibited by a human agent so long as the data on which introspection framework 131 relies was collected during the interaction with the environment. The multi-level introspection framework 131 may be flexibly applied with different modes at different RL stages. For instance, while most explainable RL approaches focus on one particular explanation form performed after the RL agent has completed learning, explanation system 130 may apply introspection framework 131 when RL agent 111 is operating in different modes and at different times, such as: during learning by tracking the learning progress and acquired preferences of RL agent 111; after learning by summarizing the most relevant aspects of the interaction; passively, where user 162 can query RL agent 111 regarding its current goals and to justify behavior of RL agent 111 at any given situation; and proactively, where RL agent 111 requests input from user 162 in situations where its decision-making is more uncertain or unpredictable.

FIG. 2 is a block diagram illustrating an example computing system configured to execute systems of FIG. 1 in accordance with the techniques of the disclosure. In the example of FIG. 2, computing system 200 includes computation engine 230, one or more input devices 202, one or more communication units 203, and one or more output devices 204.

Computation system 230 includes explanation system 130, machine learning system 102, elements 150, and interaction data 122. Explanation system 130 and machine learning system 102 may represent software executable by processing circuitry 206 and stored on storage device 208, or a combination of hardware and software. Such processing circuitry 206 may include any one or more of a microprocessor, a controller, a digital signal processor (DSP), an application specific integrated circuit (ASIC), a field-programmable gate array (FPGA), or equivalent discrete or integrated logic circuitry, for example.

Computation engine 230 may store elements 150 and interaction data 122 on storage device 208. Storage device 208 may include memory, such as random access memory (RAM), read only memory (ROM), programmable read only memory (PROM), erasable programmable read only memory (EPROM), electronically erasable programmable read only memory (EEPROM), flash memory, comprising executable instructions for causing the one or more processors to perform the actions attributed to them. In some examples, at least a portion of computing system 200, such as processing circuitry 206 and/or storage device 208, may be distributed across a cloud computing system, a data center, or across a network, such as the Internet, another public or private communications network, for instance, broadband, cellular, Wi-Fi, and/or other types of communication networks, for transmitting data between computing systems, servers, and computing devices.

Machine learning system 102 may collect one or more experiential episodes that are based on an initial (i.e., an arbitrary) state of the environment, past actions or sequences of actions performed by RL agent 111 in response to the initial state, and an outcome or sequence of outcomes/rewards of the past actions. In some examples, each experiential episode includes at least one action and at least one reward. Machine learning system may store the one or more experiential episodes in interaction data 122. In some examples, machine learning system 102 may store the one or more experiential episodes 120 as one or more experiential tuples. In some examples, each experiential tuple is in the form <s, a, s′, r> and comprises a historical initial state s of the environment, a historical action a performed by RL agent 111, a historical resulting state s′ of the environment, and a historical resulting reward r for RL agent 111. Reinforcement learning engine 110 generates reinforcement learning model 112 from interacting with an environment, which may include interactions represented as one or more experiential episodes, to train RL agent 111 to perform one or more actions within the environment. In an example where reinforcement learning model 112 is a Deep Q Network, reinforcement learning engine 110 may update one or more Q-value network parameters of reinforcement learning model 112 based on training data. Other example RL algorithms that are implemented by RL agent 111 include Monte Carlo, Q-learning, deep deterministic policy gradient (DDPG), asynchronous advantage actor-critic, Q-learning with normalized advantage functions, trust region policy optimization, state-action-reward-state-action and variations thereof, proximal policy optimization, twin-delayed DDPG, and soft actor-critic, and any combination thereof.

In some examples, one or more output devices 204 are configured to output, for presentation to a user, information pertaining to machine learning system 102. Output devices 204 may include a display, sound card, video graphics adapter card, speaker, presence-sensitive screen, one or more USB interfaces, video and/or audio output interfaces, or any other type of device capable of generating tactile, audio, video, or other output. Output devices 204 may include a display device, which may function as an output device using technologies including liquid crystal displays (LCD), quantum dot display, dot matrix displays, light emitting diode (LED) displays, organic light-emitting diode (OLED) displays, cathode ray tube (CRT) displays, e-ink, or monochrome, color, or any other type of display capable of generating tactile, audio, and/or visual output. In other examples, output devices 204 may produce an output to a user in another fashion, such as via a sound card, video graphics adapter card, speaker, presence-sensitive screen, one or more USB interfaces, video and/or audio output interfaces, or any other type of device capable of generating tactile, audio, video, or other output. In some examples, output devices 204 may include a presence-sensitive display that may serve as a user interface device that operates both as one or more input devices and one or more output devices. Output devices 204 may include an example of display device 160 of FIG. 1.

In the example of FIG. 2, computing system 200 may provide user input to computation engine 230 via one or more input devices 202. A user of computing system 200 may provide input to computing system 200 via one or more input devices 202, which may include a keyboard, a mouse, a microphone, a touch screen, a touch pad, or another input device that is coupled to computing system 120 via one or more hardware user interfaces.

Input devices 202 may include hardware and/or software for establishing a connection with computation engine 230. Input devices 202 may receive sensor data or observations indicated by sensor data. In some examples, input devices 202 may communicate with computation engine 230 via a direct, wired connection, over a network, such as the Internet, or any public or private communications network, for instance, broadband, cellular, Wi-Fi, and/or other types of communication networks, capable of transmitting data between computing systems, servers, and computing devices. Input devices 202 may be configured to transmit and receive data, control signals, commands, and/or other information across such a connection using any suitable communication techniques to receive the sensor data. In some examples, input devices 202 and computation engine 230 may each be operatively coupled to the same network using one or more network links. The links coupling input devices 202 and computation engine 230 may be wireless wide area network link, wireless local area network link, Ethernet, Asynchronous Transfer Mode (ATM), or other types of network connections, and such connections may be wireless and/or wired connections.

One or more communication devices 203 of computing system 320 may communicate with devices external to computing system 200 (or among separate computing devices of computing system 200) by transmitting and/or receiving data, and may operate, in some respects, as both an input device and an output device. In some examples, communication devices 203 may communicate with other devices over a network. In other examples, communication devices 203 may send and/or receive radio signals on a radio network such as a cellular radio network. Examples of communication devices 203 include a network interface card (e.g. such as an Ethernet card), an optical transceiver, a radio frequency transceiver, a GPS receiver, or any other type of device that can send and/or receive information. Other examples of communication devices 203 may include Bluetooth®, GPS, 3G, 4G, and Wi-Fi® radios found in mobile devices as well as Universal Serial Bus (USB) controllers and the like.

Explanation system 130 may further implement an explanation framework using results from introspection framework 131 and by prompting introspection analyses. Explanation for autonomous agents requires determining not just what to explain but also how and when. Elements 150 described here provide the content for explanation. This disclosure describes insights on how different types of elements 150 can be used to expose the behavior of RL agent 111 to a human user, justifications regarding its decisions, situations in which input from the user might be needed, etc.

Explanation system 130 may provide generate and output result data in a variety of ways. For most of the types of elements 150, explanations can be converted from the elements 150 data by coupling them with natural language templates that convert the generated elements to human-readable text. For some elements 150, explanation system 130 may generate visual tools such graphs and images to highlight important situations—including relevant observation features, such as showing identified sequences within an environment that are represented in elements 150.

In an autonomy setting—particularly for learned autonomy—explanation system 130 may operate with different modes for RL agent 111. In a passive mode, explanation system 130 may construct explanations for output in response to explicit queries from a user. For example, after training RL agent 111 in some task, the user may seek to validate the learning by asking the RL agent 111 to analyze particular situations, its motivations, its foreseeable plans, etc. To that end, explanation system 130 can use the various analyses of introspection framework 131 to summarize the learned policy, i.e., abstract a strategy, or identify the most important situations. The explanation framework of explanation system 130 should also be able to operate in a proactive mode, in which RL agent 111 initiates explanation, whether to avert surprise or to request assistance. For example, while RL agent 111 is learning, it may use the identified uncertain, unpredictable, or low-valued situations to request input from a user, such as a decision about which action to take in a situation. This input may be particularly useful in situations where RL agent 111 alone is not able to perform optimally, e.g., because it is learning in a partially-observable domain. Interaction with the user may occur in various forms, by the user providing input indicating which action to perform in some situation, corrective rewards, or higher-level guidance. The explanations provided by explanation system 130 in this setting provide the user with the context within which to give feedback to better influence the learning process for RL agent 111.

Explanation system 130 may also operate at different times. As a result, the techniques may enable a differential analysis identifying how the elements 150 change given two histories of interaction of an RL agent 111 with an environment. By analyzing these changes, explanation system 150 or a user may explain transformations of the behaviors of RL agent 111, changes in the environment, identify novel situations, acquired knowledge, and so forth. This analysis can be used during training to assess the learning progress of RL agent 111. Another possibility is to compare between the behavior of RL agent 111 during and after training to identify which challenges were overcome after learning, and which situations remained confusing, uncertain or unpredictable. Finally, explanation system 130 can apply differential analysis to data captured by a novice/learning RL agent and an expert RL agent in the task. This can be useful to “debug” the behavior of RL agent 111 and identify its learning difficulties or assess how its acquired goals differ from those of the expert, for example.

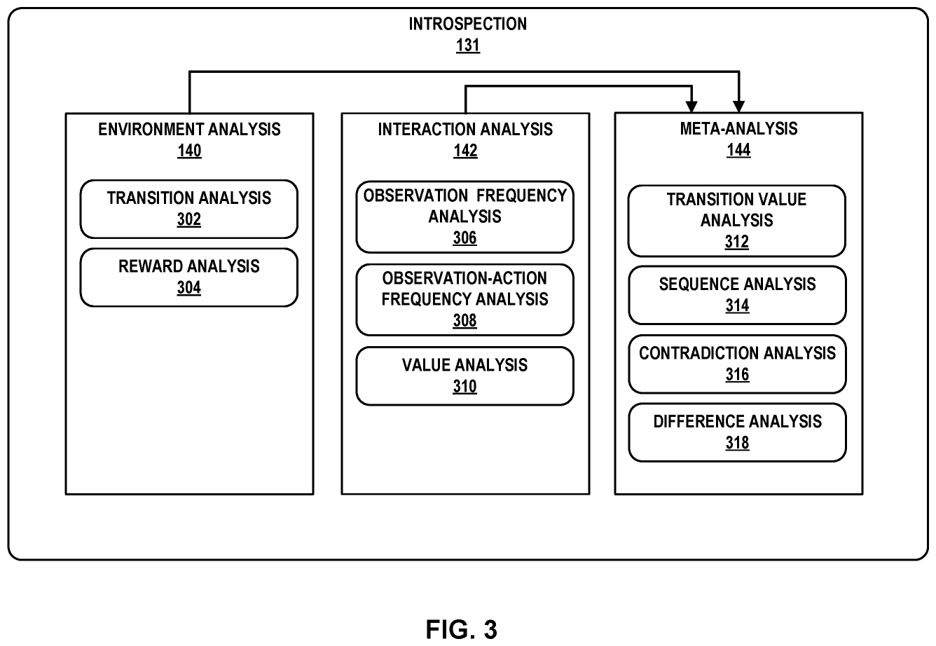

FIG. 3 is a block diagram illustrating an example of multi-level introspection framework 131 of FIG. 1 in further detail, in accordance with the techniques of the disclosure. Each of environment analysis level 140, interaction analysis level 142, and meta-analysis level 144 includes one or more of analysis functions 302, 304, 306, 308, 310, 312, 314, 316, and 318 that process interaction data 122 to generate elements 150. Each of the analysis functions may be implemented in software instructions or code executed by a computing system, e.g., computing system 200 of FIG. 2 or a standalone explanation system 130 as illustrated in FIG. 1.

Environment analysis level 140 includes transition analysis 302 and reward analysis 304 to apply environment analysis functions to analyze characteristics of the task or problem (the MDP) that the RL agent 111 is to solve. Environment analysis functions are applied by transition analysis 302 and reward analysis 304. Transition analysis 302 applies transition analysis functions described below. For transition analysis 302, the estimated transition probability function \hat{P}(z, a, z′) can be used to expose the environment's dynamics. Namely, the function allows the identification of certain and/or uncertain transitions, as defined by a threshold for example. Given an observation z and an action a, transition analysis 302 measures the transition certainty associated with (z, a) according to how concentrated are the observations z′∈Z following (z, a). In particular, transition analysis 302 uses the evenness of the distribution over observations following (z, a) as the normalized true diversity (information entropy) by resorting to the probabilities stored in \hat{P}. Distribution evenness of values Q(s, a) or policies π(s, a) may be calculated according to function ε(P)=−Σᵢ₌₀ⁿpᵢlnpᵢ/lnn. Formally, let p(X) be a probability distribution over xᵢ∈X, i=1, . . . , N of set X. The evenness of p over X is then provided by ξ(X)=−Σₓ_{ᵢ}_{∈X}+p(xᵢ)lnp(xᵢ)/lnN, where X⁺≐∀_{x∈X}:p(xⱼ)>0. The evenness measure is used to calculate the dispersion of distribution over actions according to ξ_{z}=ξ(π(z)), where π is any policy of interest. An interaction policy of RL agent 111 may be approximated using \hat{π}(z)=n(z, [symbol] )/n(z). This formulation may retain information about the agent's history of interaction beyond the learned “optimal” policy by, e.g., capturing situations that were harder to learn.

Explainability purpose is another element that can be used to reveal the confidence of RL agent 111 in its decisions. Situations where RL agent 111 is uncertain of what to do indicate opportunities to ask a user for help. They are also particularly important because people tend to require explanations mostly for abnormal behavior. On the other hand, certain situations correspond to what the agent has learned well and where its behavior is more predictable.

Certain and uncertain transitions denote situations in which the next state is easy and hard, respectively, to be predicted by RL agent 111. The certainty of an action a may be computed according to Σ_{z∈} [symbol] ξ_{za}( [symbol] )/| [symbol] |. Certain and uncertain observation-features are values of observation features that are active, on average, whenever certain and uncertain observation-action pairs occur. The certainty of a feature zⁱ may be calculated by averaging the evenness ξ_{za}( [symbol] ) for all observations z∈ [symbol] in which zⁱ is active.

Transitions leading to many different states—according to a given threshold—have a high evenness and are considered uncertain. Likewise, transitions leading only to a few states have a low evenness and are considered certain. This analysis thus highlights the certain and uncertain elements of the transitions, actions, and observation features of RL agent 111. Uncertain elements are especially important as people tend to resort to “abnormal” situations for the explanation of behavior. This information can also be used by RL agent 111 in a more proactive manner while interacting with the environment. For example, RL agent 111 can express its confidence in the result of its actions when necessary or request the help of a human user when it faces a very uncertain situation. Representations of certain and uncertain transitions identified by transition analysis 302 may be stored to elements 150.

Reward analysis 304 applies reward analysis functions to identify elements indicating uncommon situations regarding the reward received by RL agent 111 during its interaction with the environment, as defined by a threshold for example. The idea of this analysis is to identify uncommon situations regarding the reward received by the agent during its interaction with the environment. As \hat{R} corresponds to a model of the rewards received by RL agent 111, parts of the true reward function may have not been captured as the model will reflect the agent's behavior in the environment. Notwithstanding, the purpose of the framework is to analyze a particular history of interaction rather than the fidelity of the models or capturing idealized behavior. Uncommon situations include those in which observation-action reward outliers, i.e., (z, a) pairs in which, on average among all other states and actions, RL agent 111 received significantly more/less reward. This information may be used to identify situations in which RL agent 111 is likely to receive relatively low or high rewards. The following elements are analyzed:

Average reward: The overall average reward collected by RL agent 111 in all visits to the environment may correspond to r̅= [symbol] \hat{R}(z,a)/| [symbol] || [symbol] |.

Observation-action reward outliers: Uncommon situations also include those in which there are feature-action reward outliers, which correspond to feature-action pairs that are, on average among all observations taken, significantly more or less rewarding than other pairs. A given observation-action pair z, a is considered an outlier situation if: |\hat{R}(z, a)−r̅|>λ_{σ}σ_{r̅}, where σ_{r̅} is the standard deviation of r̅ and λ_{σ} is a given threshold to determine outliers. This information may be used to identify situations in which the agent is likely to receive relatively low or high rewards.

Action reward average: the reward received by the agent by executing some action, on average among all possible observations, i.e., corresponding to r̅ₐ̅= [symbol] \hat{R}(z, a)/| [symbol] |. This information can be used to determine which actions from the agent's repertoire are more or less rewarding. In addition, the variance associated with each reward average can be used to identify actions that are more or less risky.

Feature-action reward outliers: correspond to feature-action pairs that are, on average among all observations taken, significantly more or less rewarding than other pairs. For this we use the same method used to identify observation-action outliers. The rationale for this element comes from the fact that, in typical RL scenarios, the agent designer defines positive/negative rewards to be provided to the agent when it interacts with elements of the environment in a correct/incorrect manner, respectively. For example, RL agent 111 may have to interact with the appropriate object in order to achieve some sub-goal. However, in factored-MDPs, the reward from executing some action after making some observation is “diluted” among all the features that were active at that time. Therefore, this element may be used to denote significant individual contributions of features to the rewards for RL agent 111. Representations of uncommon situations identified by reward analysis 304 may be stored to elements 150.

Interaction analysis level 142 includes observation frequency analysis 306, observation-action frequency analysis 308, and value analysis 310 to characterize the environment's dynamics and extract important aspects of the behavior and history of interaction of RL agent 111 with the environment. These apply interaction analysis functions to identify elements 150 indicating the above characterizations.

Observation frequency analysis 306 includes functions to identify elements 150 that can be computed given information stored in the counters n. Such elements 150 may include:

Observation coverage: these elements include observation frequency data that correspond to how much of the observation space—regarding all possible combinations between the observation features—were actually observed by RL agent 111, as defined by a threshold for example. Formally, this element may correspond to Σ_{z∈Z}n(z)/| [symbol] |. This information may provide an indication of how much of the state-space was covered by the behavior of RL agent 111, which is an important quality of its exploration strategy.

Observation evenness: these elements include observation frequency data that correspond to an evenness if the distribution of visits to the observation space. In particular, observation frequency analysis 306 analyzes the histogram of observations using the aforementioned distribution evenness metric to generate these elements 150. Observation evenness elements can be used to infer how unbalanced the visits to states were, which in turn may denote how interesting the dynamics of the environment are, e.g., denoting situations that are physically impossible to occur, and how exploratory RL agent 111 was during the interaction with the environment, as defined by thresholds for example.

Frequent/infrequent observations: these elements observation frequency data that correspond to observations that appeared less/more frequently than others during the interaction. This element involves assessing the experience or inexperience of RL agent 111 with its environment, denoting common situations it encounters and/or rare interactions, as defined by a threshold for example. The latter may indicate states that were not sufficiently explored by RL agent 111, e.g., locations that are hard to reach in a maze or encounters with situations that are scarce, or situations that had such a negative impact on the RL agent's performance that its action-selection and learning mechanisms made sure they were rarely visited, such as a death situation in a game.

Strongly/weakly-associated feature-sets: these elements include observation frequency data that are sets of observation features (feature-sets) that frequently/rarely co-occur. To identify these elements, observation frequency analysis 306 may perform frequent pattern-mining (FPM), a datamining technique to find patterns of items in a set of transactions. In this case, each observation corresponds to a transaction containing the features that are active in that observation. In order to be used by such algorithms, we first transform each observation z∈ [symbol] into a transaction corresponding to the set of features that are active in that observation, i.e., in transactions of the form (z¹, z², . . . , z^{N}). Each observation-transaction is then repeatedly added to a database for a number of times according to its frequency, as given by n(z). Observation frequency analysis 306 may create a frequent-pattern tree (FP-tree) using a Frequent Pattern Tree or other algorithm that facilitates the systematic discovery of frequent combinations between the items in a database.

Typical FPM techniques rely on the relative frequency of cooccurrences of items to judge whether a certain item-set is considered a pattern or not. However, other metrics exist that allow the discovery of more meaningful patterns—for example, if two features are always observed together by RL agent 111, the pair should be consider interesting even if their relative frequency (i.e., compared to all other observations) is low, as defined by a threshold for example. Observation frequency analysis 306 may therefore use the Jaccard index, which can be used to measure the association strength of item-sets. Formally, given an arbitrary feature-set z= [symbol] z¹, . . . , z^{K} [symbol] of length K≤N composed by observation features zⁱ, i=1, . . . , K, the Jaccard index is given by J(z)=n(z)/ [symbol] ϑ(zⱼ)n(zⱼ), where [symbol] (z) is z's power-set, i.e., a set containing all subsets of z, ϑ(zⱼ)=(−1)^{|z}^{ⱼ}^{|+1} is a function determining the sign of the contribution of subset zⱼ in the calculation of J, n(zⱼ) is the frequency of zⱼ in the data-base and |zⱼ| denotes its length.

The Jaccard index has an anti-monotone property, meaning [symbol] J(zⱼ)≤J(z). Hence, an algorithm like FP-Growth may be used to retrieve all observation feature-sets that have a Jaccard index above a given threshold, in which case they are considered to be strongly-associated. The same property and a similar method may be used to retrieve the weakly-associated observation feature-sets, i.e., sets whose Jaccard index is below a given threshold. This element may be used to denote both patterns in the agent's perceptions or regularities in its environment, and also rare on inexistent combinations of features. In turn, these aspects may be important to explain the agent's physical interaction with the environment and expose its perceptual limitations to an external observer.

Observation frequency analysis 306 may then use an algorithm based on FP-Growth to retrieve all observation feature-sets that have a Jaccard index above/below a given threshold, in which case they are considered to be strongly-/weakly-associated. This element may be used to denote both patterns in the perceptions of RL agent 111 (or regularities in its environment), and also rare on inexistent combinations of features. In turn, these aspects may be important to explain the physical interaction of RL agent 111 with the environment and expose its perceptual limitations to an external observer.

Associative feature-rules: these elements include observation frequency data in rules generated in the form antecedent consequent for states. To generate these elements, observation frequency analysis 306 determines sets of features—the antecedent—that frequently appear conditioned on the appearance of another set of features—the consequent. Observation frequency analysis 306 may use the lift statistical measure to determine the confidence of every possible rule given the strongly-associated feature-sets. Given association rule for antecedent and consequent zₐ⇒z_{c}, interest is given by n(zₐ∪z_{c})/(n(zₐ)+n(z_{c})). These elements can be used to determine causal relationships in the environment, e.g., the physical rules of the environment or the co-appearance of certain objects, which are important elements of explanation.

Earlier observations and actions: these elements correspond to situations that were encountered by the agent in the beginning of its interaction with the environment but that have not been visited recently. This is achieved by filtering observations and observation-action pairs whose last time-step, according to the information stored in τ(z) and τ(z, a), respectively, is below a given threshold. These elements may be useful to identify rare situations encountered by the agent, or situations that the agent tends to avoid according to its action-selection policy.

Observation-action frequency analysis 308 processes interaction data 122. Interaction data 122 may be interpreted in different ways according to the policy that was used by the agent to produce the counts n(z, a). If the counts refer to behavior in which the agent was using it's learned policy, n(z,⋅) normalized approximates the policy used when observing z, i.e., the probability distribution π(z). This may be used to reveal the RL agent 111 decisions in particular situations. On contrary, if RL agent 111 was learning, it may reveal its training experience rather than approximately-optimal choices. For example, an observation-action pair may be visited more often during training because it has a high variance of reward associated, hence requiring more visits. By the end of learning, the agent might discover that said action may not be the best choice in that state—because its count could still be relatively high, this analysis may reveal interesting properties of the agent's action-selection scheme used during learning, even if an external observer is unaware of such scheme, e.g., if it is a non-technical user. This analysis may generate one or more of the following elements:

Observation-action coverage: These elements include observation frequency data that corresponds to how much of the actions were executed in the observations made. Formally, it corresponds to: Σ_{z∈Z}+ [symbol] n(z, a)/| [symbol] ⁺|| [symbol] | where [symbol] ⁺≐ [symbol] :n(z)>0. Similarly to the observation coverage, these elements reveal how exploratory the interaction of RL agent 111 with the environment was, as defined by a threshold for example.

Observation-action dispersion: These elements include observation frequency data that correspond to the mean evenness of action executions per observation. Observation-action frequency analysis 308 can generate these elements to determine how balanced or unbalanced the selection of actions by RL agent 111 in certain observations were, as defined by a threshold for example. In turn, this may denote either how exploratory RL agent 111 was during the interaction, or how stochastic the policy of RL agent 111 is, as defined by thresholds for example. In particular, for a deterministic learned policy this value should be low, i.e., concentrated action selection. In contrast, for an exploratory behavior this value should be high, meaning that the agent tried to cover as much of the state-action space as possible. Formally, the action execution dispersion for a certain observation z, denoted by ξ_{z}( [symbol] ), is given by the evenness measure used herein, where for each action a∈ [symbol] , p_{z}(a)=n(z, a)/n(z).

Certain/uncertain observations and features: besides transition certainty, observation-action frequency analysis 308 can calculate how certain or uncertain each observation is with regards to action execution. Observations where many different actions have a high count (high evenness) are considered uncertain, while those in which only a few actions were selected are considered certain. This is calculated for each observation z∈ [symbol] according to the evenness measure ξ_{z}( [symbol] ) defined above. These elements may therefore include observation frequency data that denote situations in which RL agent 111 is uncertain of or certain of what to do, therefore providing good opportunities to ask for a human user for intervention, as described elsewhere in this disclosure. For example, if an element 150 generated by observation-action frequency analysis 308 indicates uncertainty regarding an action to take in a state, computing system 200 may output a request for a decision and take the action indicated by decision data included in a response from a user. Similarly, observation-action frequency analysis 308 can identify features denoting situations in which, on average, action selection by RL agent 111 is even/uneven, as defined by a threshold for example. Uneven features may be particularly useful to abstract action-execution rules, i.e., actions that are very likely to be executed whenever some feature is active.

Value analysis 310 uses value data: Q, V and [symbol] of interaction data 122 to generate the following elements 150:

Mean value: These elements 150 provide the overall mean value of all observations, i.e., corresponding to: Σ_{z∈Z}V(z)/| [symbol] |. This can be used to determine the relative importance of observations for the agent to achieve its goals.

Observation-action value outliers: These elements 150 correspond to (z, a) pairs that are significantly more or less valued, as defined by a threshold for example. Value analysis 310 may use the same outlier-detection method used to identify the observation-action reward outliers but using the action-value function Q(z, a). These elements denote desirable situations with regards to goals of RL agent 111—high-value pairs indicate situations conducive for RL agent 111 to attain its goals while low-valued situations might prevent RL agent 111 from fulfilling its task.

Mean prediction error: These elements 150 correspond to the mean prediction error among all states and actions, which may correspond to: Σ_{z∈Z} [symbol] Q(z, a)/| [symbol] || [symbol] |. This element can be used to evaluate the accuracy of the agent's world model, i.e., how well can RL agent 111 predict the consequences and future value of its actions in most of the situations it encounters. In addition, by tracking this element while the agent is learning we may also verify its learning progress—if the average prediction error is decreasing over time, it means that the agent is learning the consequences its actions. Similarly, if the value is not decreasing or is actually increasing this may mean that the agent is not learning the policy properly or simply that the environment is very dynamic and unpredictable—even if only in the agent's perspective, i.e., caused by its perceptual limitations.

Observation-action prediction outliers: These elements 150 correspond to the (z, a) pairs that have associated a significantly higher/lower mean prediction error, as defined by a threshold. These are situations that are very hard (or easy) for RL agent 111 to learn. Together with transition uncertainty, this is an important element for explanation as people use social attribution to determine causes and judge others' behavior—e.g., when a future of RL agent 111 might be very unpredictable and uncertain. Therefore, in such situations the RL agent 111 may inform the user to avoid misunderstandings.

Actions mean value and prediction error: Value analysis 310 can also use the Q-value and the prediction-error functions to determine which actions are morse or less valued and which are more or less risky, on average. In particular, for each action a∈ [symbol] the mean value is provided by Σ_{z∈Z}Q(z, a)/| [symbol] | and similarly, the mean prediction error is Σ_{z∈Z} [symbol] (z, a)/| [symbol] |.

Meta-analysis level 144 applies meta-analysis functions that combine information from interaction data 122 and analysis levels 140, 142. Example meta-analysis functions to generate elements 150 are described below.

Transition Value Analysis 312 analysis combines information from the estimated V function and the transition function \hat{P}(z′|z, a) of RL agent 111 to generate elements 150. Transition value analysis 312 analyzes how the value attributed to some observation changes with regards to possible observations taken at the next time-step and produces one or more of the following elements 150:

Local minima/maxima: These elements 150 refer to observations whose values are greater/lower than or equal to the values of all possible next observations, as defined by a threshold for example. These elements help explain the desirability attributed by RL agent 111 to a given situation. Specifically, local maxima denote subgoals or acquired preferences—e.g., this may help explain situations in which RL agent 111 prefers to remain in the same state rather than explore the surrounding environment. In contrast, local minima denote highly-undesirable situations that RL agent 111 will want to avoid and in which typically any action leading to a different state is preferable. Formally, let [symbol] ≐{∀_{z′∈Z}: [symbol] \hat{P}(z′|z, a)>0} be the set of observed transition starting from observation z. The local minima are defined by [symbol] ₘᵢₙ≐ [symbol] : [symbol] V(z)≤V(z′). The local maxima are defined by [symbol] ₘₐₓ≐ [symbol] : [symbol] V(z)≥V(z′).

Absolute minima/maxima: These elements 150 refer to observations that are the least/most desirable for RL agent 111, i.e., whose values are less/greater than or equal to all other observations. Absolute minima are all observations z∈Z satisfying ∀_{z′∈Z}V(z)≤V(z′). These indicate the least-preferable situations that RL agent 111 encountered, situations that it should “avoid at all costs.” Absolute maxima are all observations z∈Z satisfying ∀_{z′∈Z}V(z)≥V(z′) and denote the goals of RL agent 111, i.e., situations leading RL agent 111 in attaining the highest cumulative reward.

Maximal strict-difference outliers: These elements 150 refer to observations for which the average difference in value to all next states is strictly higher or lower and maximal. These elements 150 may be extracted from the local maxima and minima. Formally this corresponds to set

$${argmax}_{z ∈ {Z}_{min} ⋃ {Z}_{max}} {max}_{{z}^{′} ∈ {𝒯}_{z}} \vert V ( z ) - V ( {z}^{′} ) \vert .$$

Such situations may denote abrupt changes in value, either negative or positive. If negative, it means RL agent 111 might get stuck in that situation as any action (selected according to its policy) would likely lead to a much lower-valued situation. If positive, it denotes situations from which RL agent 111 can easily recover.

Observation variance outliers: These elements 150 correspond to observations where the variance of the difference in value to possible next observations is significantly higher or lower, as defined by a threshold for example. These elements 150 are important to identify highly-unpredictable and especially risky situations, i.e., in which executing actions might lead to either lower- or higher-valued next states. An example function by which to compute observation variance outliers is as follows: let [symbol] ≐{∀_{z′∈Z}:\hat{P}(z′|z, a)>0} be the set of observed transitions starting from observation z and executing action a. Then, ν̅_̅{̅z̅a̅}̅= [symbol] |V(z)−V(z′)|/| [symbol] | is the mean absolute difference of values to the immediate observations z′ taken after executing a when in z. Further, let

$$σ \frac{2}{{v}_{za}}$$

denote the variance associate with ν̅_̅{̅z̅a̅}̅. For each observation z∈Z, calculate

$${\sum }_{a ∈ 𝒜} σ \frac{2}{{v}_{z a}} n ( z , a ) / n ( z ) ,$$

i.e., the mean difference variance among all actions, where each action is weighted according to the relative number of times it was executed. Finally, take the standard deviation of each mean to select the observation variance outliers, i.e., observations where the variance of the difference in value to possible next observations is significantly higher or lower than in other observations. This element is important in that it can be used to identify highly-unpredictable and especially risky situations, i.e., in which executing actions might lead to either lower- or higher-valued next states.

Sequence Analysis 314 combines information from the analyses of observation frequencies, transitions and values. Sequence analysis 314 may extract common and relevant sequences of actions from interaction data 122 indicating interactions of RL agent 111 with its environment, as defined by a threshold for example. In particular, interesting sequences involve starting from important observations identified by the other analyses, then executing the most likely action, and henceforth performing actions until reaching a local maximum representing a goal state. To discover sequences between observations, sequence analysis 314 may use the information stored in \hat{P} to create a state-transition graph where nodes are observations z and edges are the actions a denoting the observed transitions, weighted according to the probability \hat{P}(z′|z, a). Sequence analysis 314 may then implement a variant of Dijkstra's, other shortest-path first, or other path discovery algorithm to determine the most likely paths between a given source observation and a set of possible target observations.

For example, sequence analysis 314 may apply a variant of Dijkstra's algorithm whose input is a source observation zₛ∈z and a set of possible target observations, [symbol] . First, sequence analysis 314 determines the most likely paths between zₛ and each target observation zₜ∈ [symbol] . Let Pₛₜ=[z₀=zₛ, a₁, z₁, . . . , aₙ, zₙ=zₜ] denote a path between zₛ and zₜ. The probability of observing zₜ after observing zₛ and following path Pₛₜ is thus given by p(zₛ, zₜ)=Σᵢ₌₁^{|P}^{ₛₜ}^{|}\hat{P}(zᵢ|zᵢ₋₁, aᵢ). Sequence analysis 314 may then choose the most likely-valued path, denoted by P*ₛₜ, connecting the source and an optimal target observation, as given by z*ₜ= [symbol] p(zₛ, zₜ)V(zₜ), i.e., sequence analysis 314 may weight the probability of reaching future observations according to their expected value. Using this procedure, sequence analysis 314 may generate one or more of the following elements 150:

Uncertain-future observations: These elements 150 correspond to observations, taken from the local minima, maxima, variance outliers, frequent, and transition-uncertain sets of observations, from which a sequence to any local maxima (subgoal) is very unlikely, as defined by thresholds for example. These enable the identification of very uncertain situations—where RL agent 111 is not able to reason about how to reach a better situation—and hence in which help from a human user might be needed or preferable, as defined by thresholds for example.

Certain sequences to subgoal: These elements 150 denote likely sequences starting from an observation in the same set of sources used for the previous element, and then performing actions until reaching a subgoal. These elements 150 determine the typical or most likely actions of RL agent 111 when in relevant situations. Thus, they can be used to summarize behavior of RL agent 111 in the environment, e.g., by distilling a visual representation from the graph or visualizing a sequence of observations. The sequence-finding procedure can also be used by the user to query RL agent 111 about its future goals and behavior in any possible situation. Notably, this can be used to provide contrastive explanations which help reasoning about why the alternatives to some actions—the foils—are not as desirable as those chosen by the RL agent 111. Also, starting points may denote reasons for behavior while the combined transition likelihoods denote the understandings of RL agent 111—these are two crucial elements commonly used by people to explain intentional events.

Contradiction Analysis 316 combines information from the value, reward and frequency functions, the value analysis, and provided domain knowledge. Contradiction analysis 316 attempts to identify unexpected situations, where RL agent 111 was expected to behave in a certain manner, but the collected interaction data 122 indicates otherwise. Hence, explanation system 130 or a user may automatically determine the foils for behavior in specific situations. Contradiction analysis 316 may generate one or more of the following elements 150:

Contradictory-value observations: These elements 150 correspond to observations in which the actions' values distribution proportionally diverges from that of their rewards, as defined by a threshold, for example. Specifically, for each observation z∈Z, first derive probability distributions over actions in A by normalizing the values and rewards associated with z, according to the data stored in Q(z, ⋅) and \hat{R}(z, ⋅), respectively. In some cases, contradiction analysis 316 uses Jensen-Shannon divergence (JSD) that measures how similar or dissimilar two probability distributions are with regards to the relative proportion that is attributed to each element. By using this technique and based on to the information stored in Q(z, ⋅) and \hat{R}(z, ⋅), contradiction analysis 316 can identify situations with a value-reward JSD higher than a given threshold. This means that if the value attributed to actions is proportionally very different from the reward that RL agent 111 expects to receive by executing the same actions, the JSD will be close to 1. On contrary, low JSD values (close to 0) denote a low divergence hence similar, or aligned, distributions. In such situations, RL agent 111 may select (or have selected) actions that contradict what an external observer would expect. Contradiction analysis 316 may analyze the individual components of the JSD to identify which indexes are responsible for the non-alignment or dissimilarity between the distributions. In this manner, introspection framework 131 can automatically detect the contradictory situations to justify why RL agent 111 chose an unexpected action, e.g., explaining that the leads to a certain subgoal and is thus a better option compared to the expected action (contrastive explanation).

Contradictory-count observations: These elements 150 correspond to observations in which the actions' selection distribution diverges from that of their values. Contradiction analysis 316 can use a similar technique as with contradictory-value observations to calculate the count-value JSD by using the data stored in n (counters) and Q. These elements 150 can therefore identify situations where the action-selection mechanism of RL agent 111 contradicts what it has learned, e.g., by selecting more often actions in situations in which they have lower values. In turn, this could indicate one of several things: an inadequate action-selection mechanism; an unstable and hard-to-learn situation, where the value of an action changed throughout learning; that RL agent 111 has acquired a preference for an action but selected other actions with the same frequency during learning, which means that RL agent 111 has not started exploiting its learned knowledge.

Contradictory-goal observations: Contradiction analysis 316, to identify these elements 150, may assume that the system is provided with domain-knowledge regarding goal states. These correspond to situations that would normally be considered as highly desirable for RL agent 111 to perform the task by an external observer, e.g., collecting relevant items from the environment, reaching a new level in a game, etc. Based on this information, contradiction analysis 316 determines which observations that were found to be subgoals for RL agent 111 (e.g., identified local maxima) but are not in the known list of goals. Contradiction analysis 316 may in this way identify surprising situations in which RL agent 111 can justify its behavior by resorting to other types of elements 150.

Contradictory feature-actions: Contradiction analysis 316 may identify these elements 150 that are observation feature-action pairs that were found to be certain, i.e., identified by the observation-action frequency analysis, but were not in the provided list of feature-action associations. These may be used to identify surprising situations in which RL agent 111 contradicted the way it was expected to perform when observing a certain feature of the environment, e.g., it did not interact with an object in some way or collected an item that it should have avoided.

Difference analysis 318 may perform a differential analysis identifying how the elements 150 change given two histories of interaction of an RL agent 111 with an environment. By analyzing these changes, explanation system 150 or a user may explain transformations of the behaviors of RL agent 111, changes in the environment, identify novel situations, acquired knowledge, and so forth. This analysis receives as input all the interestingness elements generated by two different analyses and computes the individual differences for each element. The analysis is directed—it computes the difference between one history and another. Specifically, for elements corresponding to sets, difference analysis 318 may calculate the set difference by identifying the newly-generated items for an element, corresponding to items generated by one analysis that are not present in the other analysis's element. For elements that correspond to quantities, e.g., coverage or mean values, the difference between them is computed—the resulting scalar indicates how much the element has changed an in which direction (decreased or increased).

This differential analysis may be used for different purposes depending on the analyses it receives as input. First, it may be used during training by comparing the analyses of the history of interaction between two consecutive episodes or two time periods. For example, by tracking the difference of the mean prediction error, the agent's learning progress may be assessed—if the value is decreasing over time, it means that the agent is learning the consequences its actions. Similarly, if the value is not decreasing or is actually increasing this may mean that the agent is not learning the policy properly or simply that the environment is very dynamic and unpredictable—even if only in the agent's perspective, i.e., caused by its perceptual limitations. Similarly, changes in the (in)frequent observations can denote novel situations, which may indicate that the environment is very dynamic or that the agent is progressing in its exploration. In turn, these situations provide opportunities for RL agent 111 to ask a user for guidance in choosing the appropriate actions.

Another possibility is to use this analysis to compare the behavior of RL agent 111 during and after training. In this case, the analysis can identify which challenges were overcome after learning, and which situations remained confusing, uncertain or unpredictable. The observation-action frequency analysis can also be useful in this situation. If the counts n(z, a) refer to behavior in which RL agent 111 was using its learned policy, this may be used to reveal the agent's learned decisions in particular situations. On contrary, if it refers to when RL agent 111 was learning, it may reveal its training experience rather than approximately-optimal choices. For example, an observation-action pair may be visited more often during training because it has a high reward variance associated, hence requiring more visits. By the end of learning, the agent might discover that said action may not be the best choice in that state—hence, this analysis may reveal interesting properties of the agent's action-selection scheme used during learning, even if an external observer is unaware of such scheme, e.g., if it is a non-technical user.

Finally, differential analysis 318 can apply the differential analysis to data captured by a novice, e.g., learning agent, and an expert in the task. This can be useful to “debug” the RL agent 111 behavior and identify its learning difficulties, assess how its acquired goals differ from those of the expert, etc. Notably, our analyses framework can be used to capture interestingness elements of observed human behavior—in particular, among all the interaction data 122 that is required, only the analysis over the prediction error cannot be captured or estimated given data of a human interacting with an RL environment. This means that the differential analysis 318 can compare the behavior of a learning agent with that of a human, which allows for automatically identifying unexpected or surprising behaviors.

As described above and elsewhere herein, introspection framework 131 may analyze a history of the interaction of RL agent 111 with its environment by processing interaction data 122 generated by RL agent 111. The introspection framework 131 operates at three distinct levels, first analyzing characteristics of the task to be solved by RL agent 111, then the behavior of RL agent 111 while interacting with the environment, and finally by performing a meta-analysis combining information gathered at the lower levels. In general, the analyses generate meaningful information in the form of elements 150 from data that is already collected by standard RL algorithms, such as the Q and V functions generated by value-based methods, and state frequencies and expected rewards collected by model-based techniques.

In some examples, explanation system 130 uses statistical data that can be easily collected by RL agent 111 while it is performing the task that helps further summarizing its history of interaction. Based on this interaction data, several different types of elements 150 can be generated by the introspection framework 131.

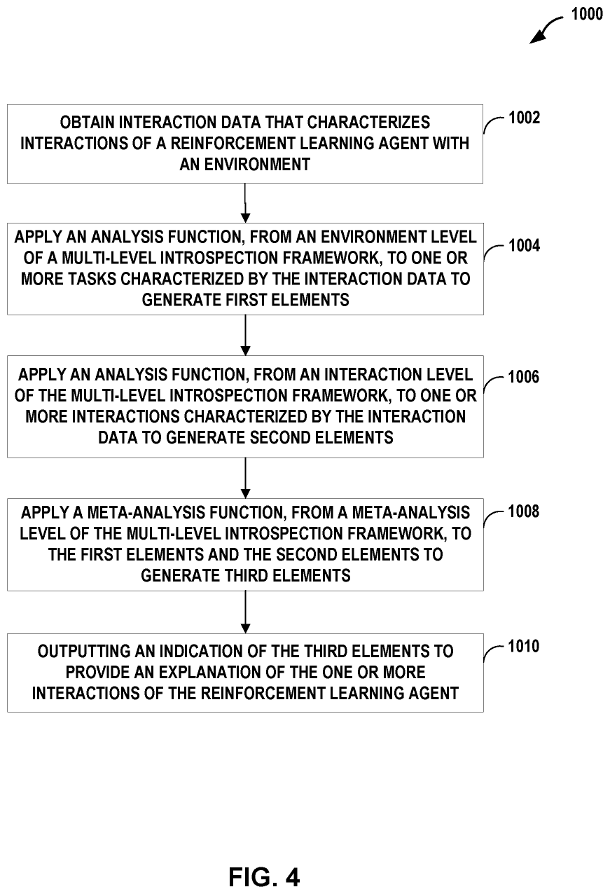

FIG. 4 is a flowchart illustrating an example mode of operation for a computing system that implements an introspection framework to facilitate explainable reinforcement learning, in accordance with one or more techniques of this disclosure. The mode of operation 1000 is described for illustration purposes with respect to systems of FIG. 1.

Explanation system 130 obtains interaction data 122 generated by RL agent 111 (1002). Interaction data 122 characterizes one or more tasks in an environment. Interaction data 122 also characterizes one or more interactions of RL agent 111 with the environment performed according to trained policies for RL agent 111. RL model 112 may include the trained policies.

Explanation system 130 processes interaction data 122 with introspection framework 131. Explanation system 130 process interaction data 122 to apply a first analysis function to the one or more tasks to generate first elements (1004). The one or more tasks are characterized by interaction data 122. Environmental analysis level 140 may include the first analysis function. As described above, environment analysis level 140 may perform transition analysis 302 functions and reward analysis 304 functions. These functions may include, for instance, the estimated transition probability function, a distribution evenness function. First elements generated by transition analysis 302 functions may include certain/uncertain transitions and certain/uncertain observation-features. Reward analysis function 304 may include the first analysis function. As described above, reward analysis 304 functions may include computing averages of (z, a) pair or feature-action pair rewards and identifying outliers in these pairs using, e.g., a normal distribution or other distribution outlier identification function. First elements generated by reward analysis 304 functions may include observation action reward outliers and feature-action reward outliers, average reward, and action reward coverage, for example.

Explanation system 130 processes interaction data 122 to apply a second analysis function to the one or more interactions to generate second elements (1006). Interaction analysis level 142 may include the second analysis function. As described above, interaction analysis level 142 may include observation frequency analysis 306 functions, observation-action frequency analysis 308 functions, and value analysis 310 functions. Elements generated by interaction analysis level 142 may include observation coverage, observation dispersion or evenness, frequent/infrequent observations, strongly/weakly-associated feature-sets, associative feature-rules, observation-action coverage, observation-action dispersion or evenness, certain/uncertain observations and features, observation-action value outliers, mean value, mean prediction error, observation-action prediction outlier, actions mean value and prediction error, and certain/uncertain observations and features, for example.

Explanation system 130 processes interaction data 122 to process at least one of the first elements and the second elements to generate third elements (1008). The third elements may denote one or more characteristics of the one or more interactions. To process the at least one of the first elements and the second elements to generate third elements, explanation system 130 may apply a function included in meta-analysis level 144, which includes transition value analysis 312 functions, sequence analysis 314 functions, contradiction analysis 316 functions, and difference analysis 318 functions. Elements generated by applying functions included in meta-analysis level 144 may include local minima/maxima, absolute minima/maxima, maximal strict-difference observations, observation variance outliers, uncertain-future observations, certain sequences to subgoals, contradictory-value observations, contradictory-count observations, contradictory-goal observations, and contradictory feature-actions, for example.

Explanation system 130 may then output an indication of the third elements to a user to provide an explanation of the one or more interactions of the reinforcement learning agent (1010).

The techniques described in this disclosure may be applicable in many scenarios for different types of automated systems. For example, interest in self-driving vehicles has continued to grow over the past several years. While impressive technological advances have been made, incidents involving unexpected behavior in novel situations continue to be a big barrier to trust. The introspection framework applied by a system described herein may enable the system to extract an RL agent's learned structures and traces of its behavior (e.g., policy networks and examples of successful and unsuccessful navigations through the city streets at different times of day), extract elements capturing significant moments of its behavior (e.g., segments where it always slows down, situations where it is highly uncertain of the next action, streets it traverses exactly the same way, or occasions where executing the “wrong action” can have disastrous consequences), and present them to a human user or to a system developer in various forms (e.g., video clips from the car's cameras, snapshots, route maps). Developers can use this information to fine-tune the system (e.g., by acquiring training scenarios in problematic situations or encoding exceptions) while users can use it to tailor their use of the system (e.g., by avoiding self-driving mode in streets under construction or during inclement weather).

Reinforcement learning is also a popular approach to learning policies to guide dialogue in various conversational assistant settings with a dialogue system. The introspection framework applied by a system described herein may enable the system to obtain the dialogue system's learned policies (e.g., for attending to a customer on a help line or for making dinner reservations in a new city) along with example dialogues leading to success (e.g., a dinner reservation made) or failure (e.g., a service representative needing to handle the customer call) and extract elements capturing important moments in the dialogues (e.g., sequences of questions and answers always present in successful interactions or situations that always result in forwarding to a human). These elements can be presented as chat log snippets or audio transcripts, for example, to both system developers and human users to enable them to understand where the system is already competent and where it is not and to modify the system or their use of it accordingly (e.g., to always specify a specific cuisine or to train with an automated helpline to handle more questions about an old but popular camera model).

Reinforcement learnings methods are also starting to be applied in control problems across industrial systems for resource management, e.g., to control power systems, computer network routing, or even to perform automated trade execution. In general, these systems are trained to control the flow of some quantity (such as information, power, or orders) across a large and complex network of devices, sometimes at very short time scales. This results in enormous amounts of data, and manual inspection to characterize system behavior or identify faulty behavior is highly infeasible. The introspection framework applied by a system described herein may enable the system to highlight critical situations to help “debug” such systems. For example, the elements could identify that certain communication patterns may cause a network to become overloaded, which in turn could inform experts on how to re-design network topology and policy to avoid such situations. Other elements could identify risky decision points, where taking the “wrong” decision at one (possibly rare) situation could lead to disastrous consequences in the future, e.g., performing a specific trading strategy under uncertain market conditions could lead to poor performance. Experts could then modify the system to mitigate this risk or decide to pass on control to a human operator whenever the risky situation identified by the introspection framework occurs.

The techniques described in this disclosure may be implemented, at least in part, in hardware, software, firmware or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

Such hardware, software, and firmware may be implemented within the same device or within separate devices to support the various operations and functions described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware or software components, or integrated within common or separate hardware or software components.

The techniques described in this disclosure may also be embodied or encoded in a computer-readable medium, such as a computer-readable storage medium, containing instructions. Instructions embedded or encoded in a computer-readable storage medium may cause a programmable processor, or other processor, to perform the method, e.g., when the instructions are executed. Computer readable storage media may include random access memory (RAM), read only memory (ROM), programmable read only memory (PROM), erasable programmable read only memory (EPROM), electronically erasable programmable read only memory (EEPROM), flash memory, a hard disk, a CD-ROM, a floppy disk, a cassette, magnetic media, optical media, or other computer readable media.

What is claimed is:

1. A computing system comprising:
a computation engine comprising processing circuitry,
wherein the computation engine is configured to obtain interaction data generated by a reinforcement learning agent, the interaction data characterizing one or more tasks in an environment and characterizing one or more interactions of the reinforcement learning agent with the environment, the one or more interactions performed according to trained policies for the reinforcement learning agent,
wherein the computation engine is configured to process the interaction data to apply a first analysis function to the one or more tasks to generate first elements,
wherein the computation engine is configured to process the interaction data to apply a second analysis function to the one or more interactions to generate second elements, the first analysis function different than the second analysis function,
wherein the computation engine is configured to process at least one of the first elements and the second elements to generate third elements denoting one or more characteristics of the one or more interactions, and
wherein the computation engine is configured to output an indication of the third elements to a user to provide an explanation of the one or more interactions of the reinforcement learning agent with the environment.

2. The computing system of claim 1,
wherein the computation engine is configured to output a request for a decision for one or more actions to perform by the reinforcement learning agent within the environment,
wherein the computation engine is configured to receive, from the user, decision data indicating a decision of the user responsive to the request for the decision, and
wherein the computation engine is configured to process the decision data to modify the trained policies for the reinforcement learning agent, retrain the reinforcement learning agent, or provide control to the reinforcement learning agent.

3. The computing system of claim 1,
wherein the computation engine is configured to execute the reinforcement learning agent to perform the one or more tasks to generate the trained policies.

4. The computing system of claim 1,
wherein the first analysis function comprises a transition analysis function,
wherein to generate the first elements, the computation engine applies the transition analysis function to the one or more interactions to identify a reinforcement learning agent transition having a certainty level that meets a threshold, and
wherein the first elements comprise an indication of the identified reinforcement learning agent transition.

5. The computing system of claim 1,
wherein the first analysis function comprises a reward analysis function,
wherein to generate the first elements, the computation engine applies the reward analysis function to rewards of the one or more interactions to identify an interaction having a reward value that meets a distribution threshold, and
wherein the first elements comprise an indication of the identified interaction.

6. The computing system of claim 1,
wherein the second analysis function comprises an interaction analysis function,
wherein the second elements comprise at least one of observation frequency data, outlier data, or certainty data.

7. The computing system of claim 1,
wherein the first analysis function is a function included in an environmental analysis level of a multi-level introspection framework,
wherein the second analysis function is a function included in an interaction analysis level of the multi-level introspection framework, and
wherein to process the first elements and the second elements the computation engine is configured to apply a meta-analysis function of a meta-analysis level of the multi-level introspection framework.

8. The computing system of claim 1,
wherein the first analysis function comprises a value function,
wherein the first elements comprise respective values indicating expected respective rewards for one or more state of the environment,
wherein the second analysis function comprises a transition probability function,
wherein the second elements comprise transition probability values each indicating a probability of a transition to a new state of the environment given a state of the environment and an action,
wherein to process the first elements and the second elements the computation engine is configured to compute at least one of local minima or maxima, absolute minima or maxima, observation variance outliers, or strict-difference variance outliers based on the values and the transition probability values.

9. The computing system of claim 1,
wherein the interaction data comprises counter data indicating respective numbers for at least: one or more states of the environment interacted with by the reinforcement learning agent, one or more actions performed for states of the environment, or one or more transitions of the reinforcement learning agent within the environment,
wherein the first analysis function comprises a value function,
wherein the first elements comprise respective values indicating expected respective rewards for one or more state of the environment,
wherein the second analysis function comprises a transition probability function,
wherein the second elements comprise transition probability values each indicating a probability of a transition to a new state of the environment given a state of the environment and an action,
wherein to process the first elements and the second elements the computation engine is configured to:
compute local maxima based on the values;
generate a transition graph based on the transition probability values; and
process the transition graph to identify most likely sequences of transitions of the reinforcement learning agent within the environment,
wherein the third elements comprise the most likely sequences.

10. The computing system of claim 1,
wherein the first analysis function comprises a reward analysis function,
wherein to generate the first elements, the computation engine applies the reward analysis function to rewards of the one or more interactions to identify an interaction having a reward value that meets a distribution threshold, and
wherein the first elements comprise an indication of the identified interaction,
wherein the second analysis function comprises a value analysis function,
wherein the interaction data comprises at least one: value data for one or more actions performed for states of the environment, or prediction error for one or more actions performed for the one or more states of the environment, and
wherein to generate the second elements, the computation engine applies the value analysis function to at least one of the value data or prediction error to generate outlier data,
wherein the second elements comprise the outlier data,
wherein the interaction data comprises counter data indicating respective numbers for at least: one or more states of the environment interacted with by the reinforcement learning agent, one or more actions performed for states of the environment, or one or more transitions of the reinforcement learning agent within the environment,
wherein to process the first elements and the second elements the computation engine is configured to identify contradiction data comprising at least one of contradictory-value observations, contradictory-count observations, or contradictory-goal observations, and
wherein the third elements comprise the contradiction data.

11. The computing system of claim 1, wherein to output the indication of the third elements the computation engine is configured to:
compute, based on the third elements, summary data for a plurality of analysis functions, the summary data comprising one or more of: a maxima state, a minima state, a state-action pair with associated certainty, a state with associated frequency value, a most likely sequence from a minima state to a maxima state, or a most likely sequence from a maxima state to a minima state; and
output, to a display device, the summary data.

12. The computing system of claim 1,
wherein the computation engine is configured to generate, based on the third elements, one or more training scenarios.

13. The computing system of claim 1, wherein the interaction data is for one of:
an autonomous vehicle,
a conversational assistant,
a medical system,
a network automation system,
a home automation system, or
an industrial control system.

14. The computing system of claim 1,
wherein the computation engine is configured to receive a query for a most likely sequence for the reinforcement learning agent,
wherein the third elements comprise the most likely sequence.

15. A method of explainable reinforcement learning, the method comprising:
obtaining, by a computing system, interaction data generated by a reinforcement learning agent, the interaction data characterizing one or more tasks in an environment and characterizing one or more interactions of the reinforcement learning agent with the environment, the one or more interactions performed according to trained policies for the reinforcement learning agent;
processing, by the computing system, the interaction data to apply a first analysis function to the one or more tasks to generate first elements;
processing, by the computing system, the interaction data to apply a second analysis function to the one or more interactions to generate second elements, the first analysis different than the second analysis;
processing, by the computing system, at least one of the first elements and the second elements to generate third elements denoting one or more characteristics of the one or more interactions; and
outputting, by the computing system, an indication of the third elements to a user to provide an explanation of the one or more interactions of the reinforcement learning agent.

16. The method of claim 15,
wherein the first analysis comprises one of a transition analysis function or a reward analysis function.

17. The method of claim 15,
wherein the second analysis function comprises an interaction analysis function.

18. The method of claim 15,
wherein the second analysis function comprise one of an observation frequency analysis function, an observation-action frequency analysis function, or a value analysis function, and
wherein the second elements comprise at least one of observation frequency data, outlier data, or certainty data.

19. The method of claim 15,
wherein processing the first elements and the second elements comprises applying a meta-analysis function.

20. A non-transitory computer-readable medium comprising instructions for causing one or more programmable processors to:
obtain interaction data generated by a reinforcement learning agent, the interaction data characterizing one or more tasks in an environment and characterizing one or more interactions of the reinforcement learning agent with the environment, the one or more interactions performed according to trained policies for the reinforcement learning agent;
process the interaction data to apply a first analysis function to the one or more tasks to generate first elements;
process the interaction data to apply a second analysis function to the one or more interactions to generate second elements, the first analysis different than the second analysis;
process at least one of the first elements and the second elements to generate third elements denoting one or more characteristics of the one or more interactions; and
output an indication of the third elements to a user to provide an explanation of the one or more interactions of the reinforcement learning agent.
